(19) United States
(12) Patent Application Publication
(10) Pub. No.: US 2023/0409064 A1
(43) Pub. Date: Dec. 21, 2023

(54) PSEUDO ESR TECHNIQUE IN A MULTI-LOOP LOW-DROPOUT REGULATOR

(71) Applicant: TEXAS INSTRUMENTS INCORPORATED, Dallas, TX (US)

(72) Inventors: Varun UPADHYAYA, New Delhi (IN); Venkateswarlu RAMASWAMY T, Bangalore (IN); Ramakrishna ANKAMREDDI, Bangalore (IN)

(21) Appl. No.: 18/174,195

(22) Filed: Feb. 24, 2023

(30) Foreign Application Priority Data
Jun. 16, 2022 (IN) 202241034499

(51) Int. Cl. G05F 1/575; G05F 1/595

(52) U.S. Cl. CPC G05F 1/575; G05F 1/595

(57) ABSTRACT

In an example, a voltage regulator includes a first feedback loop. The first feedback loop includes a first transistor coupled to an input voltage terminal and a second transistor coupled to the first transistor. The first feedback loop also includes a third transistor coupled to the second transistor, and a fourth transistor coupled to the third transistor and a gate of the first transistor. The voltage regulator includes a resistor having a first terminal and a second terminal, the first terminal coupled to the first transistor and the second transistor. The voltage regulator also includes a second feedback loop, where the second feedback loop includes an amplifier having a first amplifier input coupled to the second terminal of the resistor, a second amplifier input coupled to a voltage source, and an amplifier output coupled to a gate of the second transistor.

### CROSS-REFERENCE TO RELATED APPLICATIONS

The present application claims priority to India Provisional Patent Application No. 202241034499, which was filed Jun. 16, 2022, is titled “PSEUDO ESR TECHNIQUE FOR MULTI-LOOP FLIPPED-VOLTAGE-FOLLOWER LDO WITH REVERSE CURRENT PROTECTION,” and is hereby incorporated herein by reference in its entirety.

### BACKGROUND

Linear voltage regulators are useful in power systems to receive a variable input voltage and to provide a stable, low-noise power supply. A low dropout (LDO) linear voltage regulator is a type of linear voltage regulator circuit that works well even when the output voltage is close to the input voltage, resulting in improved power efficiency over conventional regulators. A feedback loop may be useful to stabilize the LDO. If the supply and output voltages are higher than five to seven volts, the feedback loop may include a high voltage capacitor for stabilizing the LDO.

### SUMMARY

In accordance with at least one example of the disclosure, a voltage regulator includes a first feedback loop. The first feedback loop includes a first transistor coupled to an input voltage terminal and a second transistor coupled to the first transistor. The first feedback loop also includes a third transistor coupled to the second transistor, and a fourth transistor coupled to the third transistor and a gate of the first transistor. The voltage regulator includes a resistor having a first terminal and a second terminal, the first terminal coupled to the first transistor and the second transistor. The voltage regulator also includes a second feedback loop, where the second feedback loop includes an amplifier having a first amplifier input coupled to the second terminal of the resistor, a second amplifier input coupled to a voltage source, and an amplifier output coupled to a gate of the second transistor.

In accordance with at least one example of the disclosure, a voltage regulator includes a first feedback loop, where the first feedback loop includes a pass transistor coupled to an input voltage terminal and a sense transistor coupled to the pass transistor. The first feedback loop also includes a control transistor coupled to the sense transistor and a cascode transistor coupled to the control transistor. The first feedback loop includes a buffer transistor coupled to the cascode transistor and a gate of the sense transistor. The voltage regulator includes a resistor having a first terminal and a second terminal, the first terminal coupled to the sense transistor and the control transistor. The voltage regulator also includes a second feedback loop, where the second feedback loop includes an amplifier having a first amplifier input coupled to the second terminal of the resistor, a second amplifier input coupled to a voltage source, and an amplifier output coupled to a gate of the control transistor.

In accordance with at least one example of the disclosure, a low-dropout voltage regulator includes a pass transistor having a flipped-voltage-follower configuration with a control transistor, where a drain of the pass transistor is configured to provide an output voltage of the low-dropout voltage regulator. The low-dropout voltage regulator includes a first feedback loop for the voltage regulator, where the first feedback loop is configured to provide a load transient response. The first feedback loop includes the pass transistor and the control transistor. The first feedback loop also includes a cascode transistor coupled to the control transistor. The first feedback loop includes a buffer transistor coupled to the cascode transistor and a gate of the pass transistor. The low-dropout voltage regulator includes a resistor having a first terminal and a second terminal, the first terminal coupled to the pass transistor and the control transistor. The low-dropout voltage regulator also includes a second feedback loop for the voltage regulator, where the second feedback loop is configured to provide load regulation. The second feedback loop includes an amplifier having a first amplifier input coupled to the second terminal of the resistor, a second amplifier input coupled to a voltage source, and an amplifier output coupled to a gate of the control transistor.

### BRIEF DESCRIPTION OF THE DRAWINGS

FIG. 1 is a circuit diagram of an LDO with two feedback loops and an intentional resistor in accordance with various examples.

FIG. 2 is a circuit diagram of an LDO with two feedback loops and an intentional resistor in accordance with various examples.

FIG. 3 is a circuit diagram of a flipped-voltage-follower (FVF) buffer in accordance with various examples.

FIG. 4 is a circuit diagram of an FVF buffer in accordance with various examples.

FIG. 5 is a Bode plot of poles and zeros in accordance with various examples.

FIG. 6 is a circuit diagram of an FVF buffer in accordance with various examples.

FIG. 7 is a Bode plot of poles and zeros in accordance with various examples.

FIG. 8 is a circuit diagram of an FVF buffer in accordance with various examples.

FIG. 9 is a Bode plot of poles and zeros in accordance with various examples.

FIG. 10 is a Bode plot of poles and zeros in accordance with various examples.

FIG. 11 is a Bode plot of poles and zeros in accordance with various examples.

FIG. 12 is graph of a damping factor versus load current in accordance with various examples.

FIG. 13 is a Bode plot in accordance with various examples.

FIG. 14 is a circuit diagram of an FVF buffer in accordance with various examples.

FIG. 15 is a circuit diagram of an FVF buffer in accordance with various examples.

The same reference numbers or other reference designators are used in the drawings to designate the same or similar (functionally and/or structurally) features.

### DETAILED DESCRIPTION

An LDO may include one or more feedback loops that stabilize the LDO for a wide range of effective series resistance (ESR). The ESR is the resistance of a non-ideal capacitor, and the ESR occurs in series with the capacitor. The ESR may cause a variety of performance issues in an electronic circuit, such as power losses, noise, voltage drops, etc. To compensate for the ESR, one LDO includes an additional resistor coupled to a pass transistor in the load current path and samples feedback both before and after the resistor. A transfer function describes the LDO operation. The transfer function is a function that models the system's output for each input (e.g., V_{OUT}/V_{IN}). A transfer function may have one or more zeros, which is the frequency value for which the value of the numerator of the transfer function becomes zero. A transfer function may also have one or more poles, which is the frequency value for which the value of the denominator of the transfer function becomes zero. The additional resistor in this LDO adds a zero to the transfer function of the circuit. This zero tracks the pole occurring due to the output capacitance, and the additional resistor bounds the upper frequency limit of the zero to help stabilize the circuit. However, the LDO uses a high voltage capacitor in at least one of the feedback paths, which increases the area of the circuit.

In another LDO, the additional resistor is removed from the load current path, and a series resistance is realized using a sense transistor coupled to the pass transistor of the LDO. A capacitor coupled to the sense resistor provides the feedback in a feedback loop. Compared to the above described LDO, this LDO removes the resistor in series with the pass transistor. This LDO also includes the high voltage capacitor in the feedback path, which increases the area of the circuit.

In examples herein, the capacitor in the feedback path of the LDO is removed and replaced with an amplifier. To achieve a low quiescent current (I_{Q}) and good transient performance in an LDO, a flipped-voltage-follower (FVF) feedback loop is added along with a main feedback loop having a high gain error amplifier to maintain high accuracy at the output. An FVF is a buffer cell with a local feedback loop. In an FVF, a voltage output is provided at a drain of a pass transistor, which is coupled to a source of a control transistor. The drain of the control transistor is coupled to the gate of the pass transistor. A current source is also coupled to the drain of the control transistor. The FVF has low impedance at the voltage output, and can source currents much larger than the current source.

The two feedback loops described above allow feedback to be taken both before and after an additional resistor coupled to the pass transistor. The additional resistor is referred to as an intentional resistor (R_{INT}) or an FVF resistor (R_{FVF}). The two feedback loops include a high speed loop and a low speed loop. The high speed loop (e.g., the FVF loop) includes a high bandwidth amplifier for fast load transient response. The high speed loop decreases the effective output impedance due to negative feedback gain. Therefore, with higher load currents, the output pole moves to a higher frequency. The low speed loop includes a high direct current (DC) gain amplifier for good load regulation. The low-speed loop maintains output accuracy by sensing the feedback at the output node of the LDO. The R_{INT} adds a left-half plane (LHP) zero in the loop transfer function of the high speed loop that scales with the output capacitance, which helps stabilize the high speed loop by bounding the frequency movement of the zero created by the ESR. The R_{INT} acts like an ESR for the high speed loop without adding a zero to the low speed loop. The R_{INT} limits the lowest impedance on the output of the LDO, which sets an upper bound on the output pole frequency and therefore prevents complex pole pair formation at high load currents. The structure described herein provides good load regulation and better stability without a high voltage capacitor in a feedback loop that would increase area.

In another example, a sense transistor is added to avoid the use of a resistor (e.g., R_{INT} or R_{FVF}) in the load current path. The sense transistor injects a current proportional to the load through a resistor, which introduces a zero in the loop that tracks the output pole. In another example, to boost the phase margin of the LDO at full loads, the ESR zero should be moved to higher frequencies as the load increases. To move the ESR zero to higher frequencies with a load, the pass transistor to sense transistor ratio should increase with increases in the load. This increase may be realized by adding a degeneration resistance coupled between the sense transistor and a voltage supply.

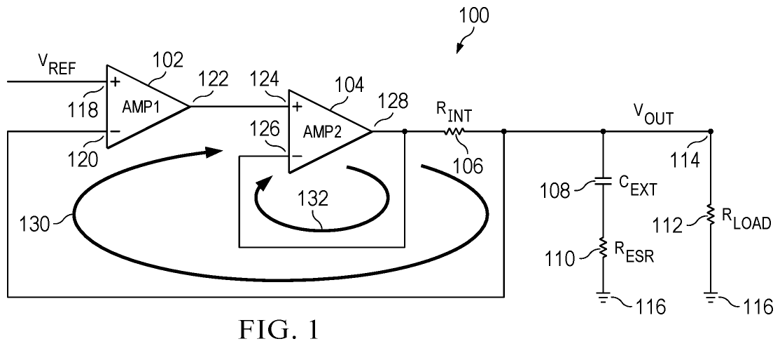

FIG. 1 is a circuit diagram of an LDO 100 with two feedback loops and an intentional resistor R_{INT} in accordance with various examples described herein. LDO 100 includes a first amplifier 102, a second amplifier 104, and R_{INT} 106. LDO 100 includes an external capacitor (C_{EXT}) 108, with an R_{ESR} 110. Capacitor 108 may also be referred to herein as a load capacitor (C_{LOAD}). A load R_{LOAD} 112 is coupled to an output node 114 that produces an output voltage V_{OUT}. R_{LOAD} 112 and R_{ESR} 110 are coupled to ground 116.

First amplifier 102 includes a first input 118 that receives a reference voltage V_{REF}, and a second input 120 that is coupled to output node 114 (V_{OUT}). First amplifier 102 includes an amplifier output 122. Amplifier output 122 is coupled to first input 124 of second amplifier 104. Second amplifier 104 has a second input 126 that is coupled to R_{INT} 106. Second input 126 is also coupled to amplifier output 128 of second amplifier 104. LDO 100 includes a first feedback loop 130 and a second feedback loop 132. First feedback loop 130 is the low speed loop as described above. First feedback loop 130 maintains good load regulation, so feedback is taken from the output at node 114. Second feedback loop 132 provides a fast load transient response. The use of second amplifier 104 in second feedback loop 132 replaces a capacitor in the feedback loop from other systems.

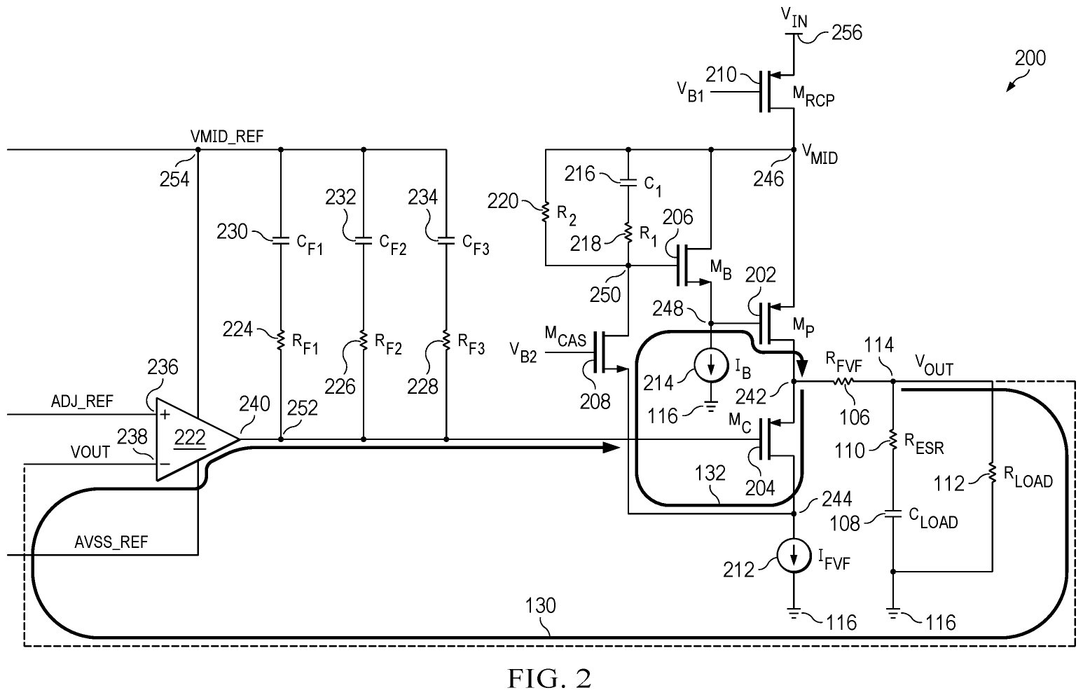

FIG. 2 is a circuit diagram of an LDO 200 with two feedback loops and an intentional resistor R_{INT} in accordance with various examples described herein. The intentional resistor R_{INT} is a resistor added to generate a pseudo ESR in an FVF LDO loop (e.g., the high speed loop) that enables zero to high ESR support. The R_{INT} avoids complex pole formation in the high speed loop. The added zero in the high speed loop extends the bandwidth of the high speed loop which improves overall transient response speed. LDO 200 is a detailed example of one implementation of LDO 100. Some components of LDO 200 are described above with respect to LDO 100, and like numerals denote like components.

LDO 200 includes a pass transistor 202 (M_{P}), control transistor 204 (M_{C}), buffer transistor 206 (M_{B}), cascode transistor 208 (M_{CAS}), and reverse current protection (RCP) transistor 210 (M_{RCP}). LDO 200 also includes current source 212 (I_{FVF}) and current source 214 (I_{B}). LDO 200 also includes capacitor 216 (C₁), resistor 218 (R₁), and resistor 220 (R₂). Capacitor 216, resistor 218, and resistor 220 may comprise an active load in one example. An active load may have a resistance that changes as overall load current increases. LDO 200 also includes a transconductance amplifier 222 and a set of feedback capacitors and resistors: resistors 224 (R_{F1}), 226 (R_{F2}), 228 (R_{F3}), and capacitors 230 (C_{F1}), 232 (C_{F2}), and 234 (C_{F3}). Transconductance amplifier 222 includes a first input 236, a second input 238, and an output 240. First input 236 receives a reference signal (ADJ_REF) and second input is coupled to output node 114 as part of first feedback loop 130. ADJ_REF is a voltage reference that defines the output voltage value V_{OUT}. ADJ_REF may be provided by an external voltage source or from an internal bandgap circuit (not shown in FIG. 2). The value of ADJ_REF may range from two to forty volts in some examples.

LDO 200 includes several nodes, such as nodes 242, 244, 246, 248, 250, 252, and 254. LDO 200 also includes a voltage terminal 256 (e.g., input voltage terminal) that provides a voltage V_{IN}.

First feedback loop 130 and second feedback loop 132 are shown in LDO 200. First feedback loop 130 is the low speed loop, also referred to as the error amplifier loop. First feedback loop 130 connects output node 114 (V_{OUT}) to transconductance amplifier 222. First feedback loop also includes a high impedance node 252 coupled to output 240, and then continues to the gate of control transistor 204. Control transistor 204 acts as a source follower for the first feedback loop 130. The gate to source of control transistor 204 has unity gain. The gain for first feedback loop 130 comes from the transconductance amplifier 222. Feedback for the first feedback loop 130 is taken after the R_{INT} 106, which is also referred to here as R_{FVF} 106 (flipped voltage follower). The R_{FVF} 106 separates the feedback points for the feedback loops 130 and 132.

Second feedback loop 132 is the high speed feedback loop. Second feedback loop 132 has an FVF configuration, and acts as a buffer. The FVF configuration boosts transient response speed. In this example, the second feedback loop 132 has unity gain. Second feedback loop 132 begins at node 242, goes through control transistor 204, through cascode transistor 208, through buffer transistor 206, and then through pass transistor 202. Second feedback loop 132 responds during load transients. The high gain stage of first feedback loop 130 is cascaded with the FVF buffer of second feedback loop 132 to achieve good load regulation and transient response. First feedback loop 130 and second feedback loop 132 are independently stabilized for all load conditions. The R_{FVF} 106 acts as an ESR for second feedback loop 132, while not adding a zero to the first feedback loop 130. Additional discussion of the second feedback loop 132 is provided below.

LDO 200 receives an input voltage V_{IN} and provides an output voltage V_{OUT} at output node 114. Pass transistor 202 provides a voltage at node 242. Node 242 is coupled to one terminal of R_{FVF} 106, while the other terminal of R_{FVF} 106 is coupled to output node 114. Current source 212 provides a bias current to bias control transistor 204. Current source 214 provides a bias current to bias buffer transistor 206. A bias voltage V_{B1} is provided to a gate of reverse current protection transistor 210 by a first bias voltage source, and a bias voltage V_{B2} is provided to a gate of cascode transistor 208 by a second bias voltage source.

In an example, pass transistor 202 has a gate coupled to a source of buffer transistor 206, a drain coupled to R_{FVF} 106 and to a source of control transistor 204, and a gate coupled to a source of buffer transistor 206. Buffer transistor 206 acts as a buffer that drives pass transistor 202. As described below, pass transistor 202 may create a pole in the transfer function. Buffer transistor 206 pushes the pole of pass transistor 202 to a higher bandwidth, which increases the bandwidth of the LDO.

Control transistor 204 has a source coupled to R_{FVF} 106, a drain coupled to a source of cascode transistor 208 and to current source 212, and a gate coupled to output 240 of transconductance amplifier 222. Cascode transistor 208 has a gate coupled to a voltage source that produces a bias voltage V_{B2}, and a drain coupled to node 250 and to a gate of buffer transistor 206.

Buffer transistor 206 includes a gate coupled to the drain of cascode transistor 208, a drain coupled to the source of pass transistor 202, and a source coupled to the gate of pass transistor 202. The source of buffer transistor 206 is also coupled to current source 214. Reverse current protection transistor 210 has a source coupled to voltage terminal 256 that provides a voltage VIM a gate coupled to a voltage source that provides a bias voltage V_{B1}, and a drain coupled to the source of pass transistor 202.

In operation, current source 212 biases control transistor 204, and V_{B1} biases reverse current protection transistor 210. Current travels from voltage terminal 256 (e.g., V_{B1}) through reverse current protection transistor 210, pass transistor 202, and then to R_{LOAD} 112. The FVF structure of pass transistor 202 and control transistor 204 provides an output voltage at node 242, which is a low impedance node. LDO 200 can provide an output voltage V_{OUT} that is close to the input voltage V_{IN}. First feedback loop 130 provides feedback from output node 114 (V_{OUT}) to an error amplifier (transconductance amplifier 222). Transconductance amplifier 222 has a high impedance node 252 at its output 240, which is coupled to the gate of control transistor 204. The feedback from first feedback loop 130 is provided to the gate of control transistor 204, which in turn affects the current through pass transistor 202 and control transistor 204. This feedback provides stability to R_{LOAD} 112.

As described above, the transfer function of the LDO 200 may have one or more poles and zeros. The frequency location of the poles and zeros is managed via the circuit design to stabilize the circuit. The poles and zeros should be designed to provide the circuit with a proper phase margin (e.g., the phase when the circuit reaches unity gain). The poles and zeros should also allow the circuit to have an appropriate bandwidth. The circuit should also be stable during operating conditions and the design should also attempt to avoid the formation of complex poles. The design consideration for managing the poles and zeros of the LDO 200 is described below.

In an example herein, pass transistor 202 may be a first transistor and control transistor 204 may be a second transistor. Cascode transistor 208 may be a third transistor and buffer transistor 206 may be a fourth transistor. Reverse current protection transistor 210 may be a fifth transistor.

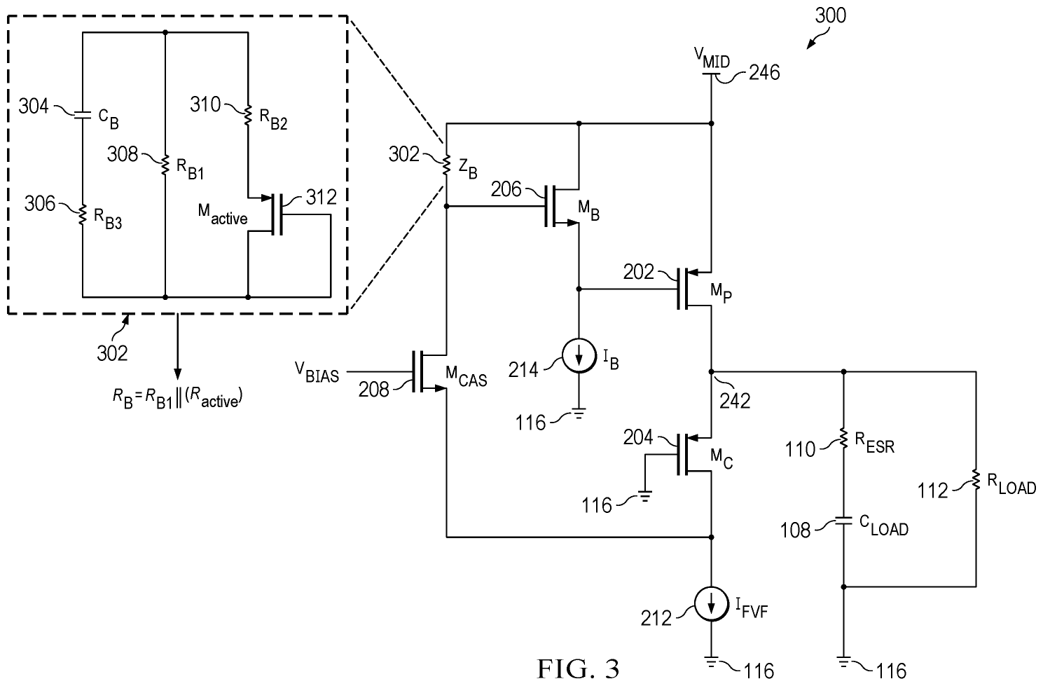

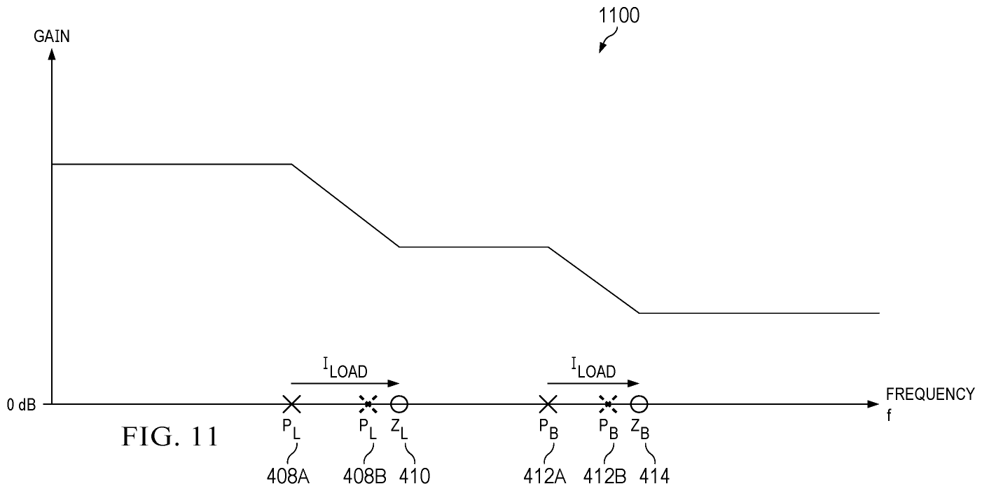

FIGS. 3-10 describe examples of the FVF buffer and second feedback loop 132. FIGS. 3-10 also describe the poles and zeros of second feedback loop 132, and the movement of those poles and zeros under various examples. FIGS. 11-13 describe the first feedback loop 130 and the poles and zeros associated with first feedback loop 130.

FIG. 3 is a circuit diagram of the FVF buffer in accordance with various examples herein. Some components of circuit 300 are described above with respect to LDO 100 and LDO 200, and like numerals denote like components. Circuit 300 is a close-up view of second feedback loop 132, with the components of first feedback loop 130 removed. R_{FVF} 106 is also removed from FIG. 3. The FVF buffer is a high bandwidth FVF loop created with pass transistor 202 to achieve a fast transient response. Second feedback loop 132 is designed to achieve a fast transient response while maintaining low quiescent current (I_{Q}) and ensuring stability across all values of load capacitor 108 and R_{ESR} 110 combinations.

Current source 212 (I_{FVF}) provides a bias current to bias control transistor 204. Cascode transistor 208 provides protection for the circuit. Load 302 (Z_{B}) is an active load, which means the resistance component of load 302 could change as overall load current increases. A buffer drives the pass transistor 202, where the buffer is buffer transistor 206. Pass transistor 202 may be a large transistor that produces a pole in the transfer function. Buffer transistor 206 pushes the pole of the pass transistor 202 further out in frequency to increase the stability of the circuit, as described below.

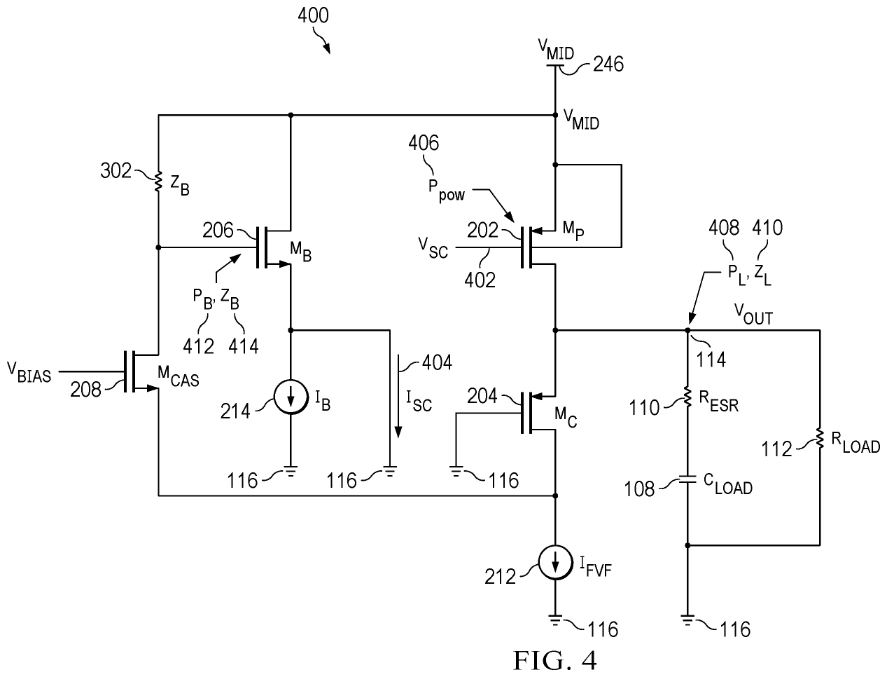

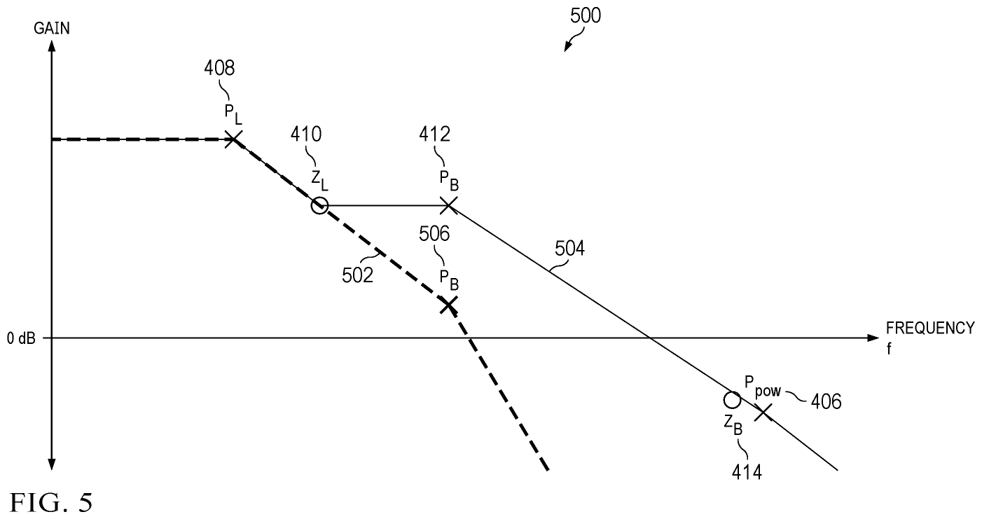

In this example, the first pole and zero combination in the transfer function is provided by the ESR (R_{ESR} 110) and load capacitor 108. The second pole and zero combination comes from the active load 302, which has a buffer capacitance 304 (C_{B}), a series resistance 306 (R_{B3}), and the active load component. The active load component R_{B} is a combination of resistance 308 (R_{B1}) and R_{active}. R_{active} is resistance 310 (R_{B2}) in series with 1/gₘ of transistor 312 (M_{active}), where 1/gₘ is the resistance of the transistor 312. Therefore, the active load component R_{B} is R_{B1}∥R_{active}. FIGS. 4 and 5, described below, demonstrate the buffer loop analysis and a Bode plot for the FVF shown in circuit 300.

FIG. 4 is a circuit diagram of the FVF buffer in accordance with various examples herein. Some components of circuit 400 are described above with respect to FIGS. 1, 2, and 3, and like numerals denote like components. For the analysis of circuit 400, the loop may be broken at the gate of pass transistor 202. V_{SC} 402 is the voltage at the gate of pass transistor 202, and I_{SC} 404 is a current from the source of buffer transistor 206 to ground 116. A detailed discussion of the transfer function is omitted herein. Instead, FIG. 5 and other plots described herein demonstrate the location and movement of poles and zeros in the described circuits.

Various poles and zeros are labeled in circuit 400. These are the poles and zeros of the transfer function for circuit 400. A pole 406 (P_{POW}) is created by pass transistor 202. Load pole 408 (P_{L}) and load zero 410 (P_{Z}) are found at output node 114. Buffer pole 412 (P_{B}) and buffer zero 414 (B_{Z}) are found at the gate of buffer transistor 206. This system has three poles and two zeros.

FIG. 5 is a Bode plot 500 of the poles and zeros for circuit 400 in accordance with various examples herein. Bode plot 500 shows two curves, 502 and 504. Curve 502 is the Bode plot without R_{ESR} 110 in circuit 400. Curve 504 is the Bode plot with R_{ESR} 110 in circuit 400. The poles and zeros described above with respect to FIG. 4 are labeled in Bode plot 500. Poles are labeled with an X, and zeros are labeled with a O. As described herein, R_{ESR} 110 stabilizes the circuit 400 for a wide ESR range (e.g., 0 to 5 Ohms).

In curve 502 (without R_{ESR} 110), a load pole 408 (P_{L}) occurs, and then the next pole is buffer pole 506 (P_{B}). The load zero 410 (Z_{L}) is not present without the R_{ESR} 110, so no zero exists in curve 502 between load pole 408 and buffer pole 506. In curve 504, the R_{ESR} 110 adds the load zero 410 (Z_{L}). Therefore, curve 504 represents a pole-zero-pole system. In this pole-zero-pole system, the gain is flat until load pole 408, then the gain begins to drop. At the location of load zero 410, the gain flattens until the location of buffer pole 412. Then, at buffer pole 412, the gain begins to fall again. The pole-zero-pole system with R_{ESR} 110 has a phase margin of 90 degrees (e.g., the phase when the system reaches 0 dB or unity gain). Another feature of the system with R_{ESR} 110 is that the bandwidth is extended. Curve 504 has greater bandwidth compared to curve 502. An LDO with a fast loop (second feedback loop 132) as described herein avoids complex pole formation. Complex poles are often detrimental to stability and are usually avoided.

Because curve 504 provides these advantages compared to curve 502, it is advantageous for the load zero 410 to occur between load pole 408 and buffer pole 412. Therefore, the circuit may be designed to bound the movement of the load zero 410 to produce a stable system with high bandwidth. The process for bounding the load zero 410 is described below.

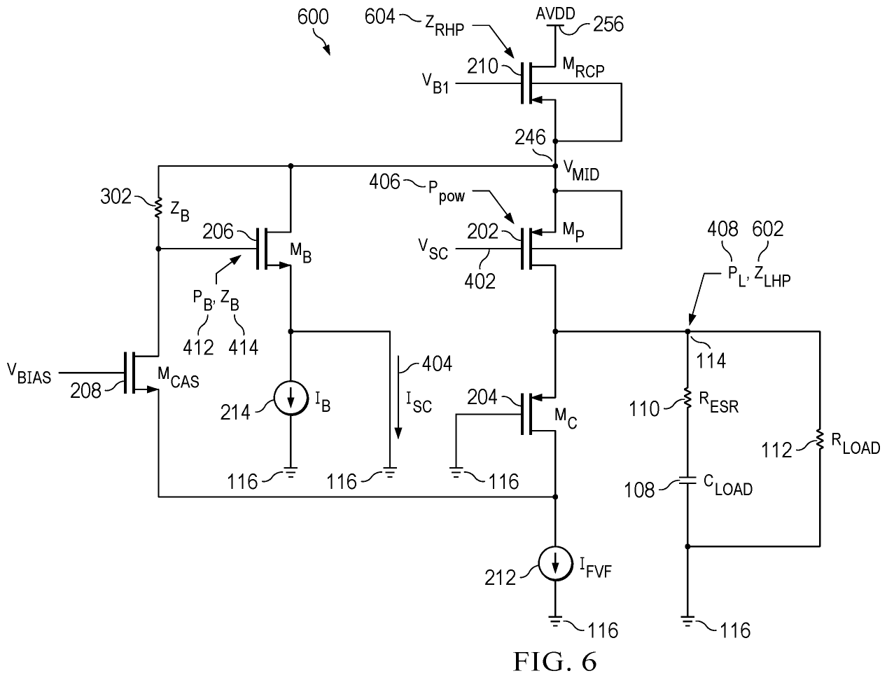

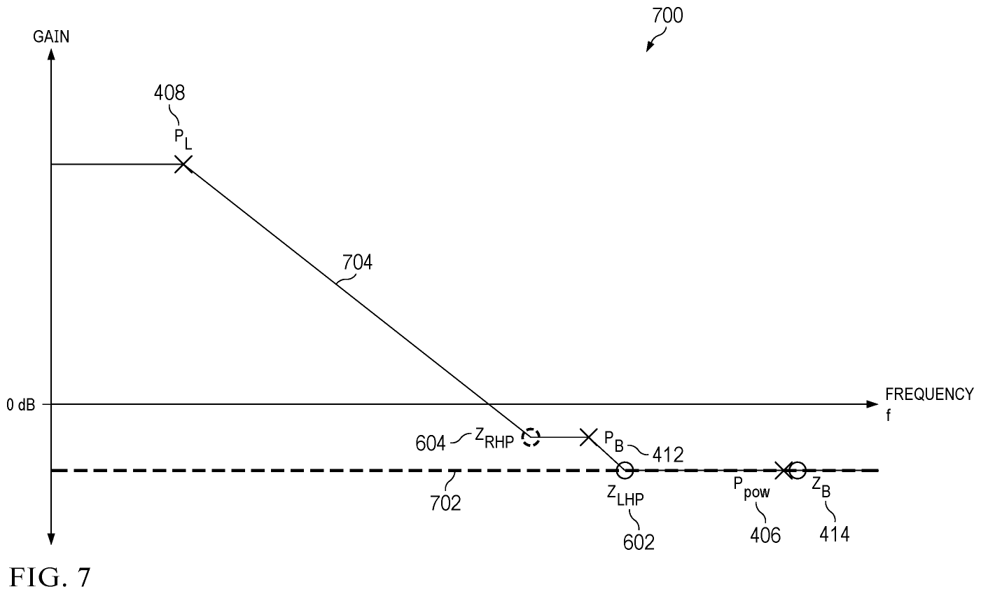

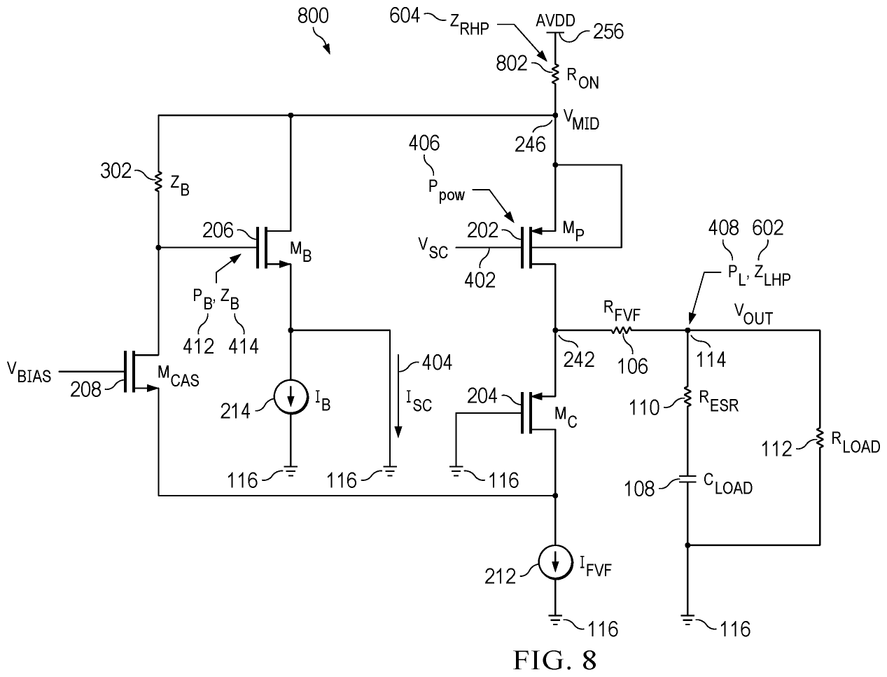

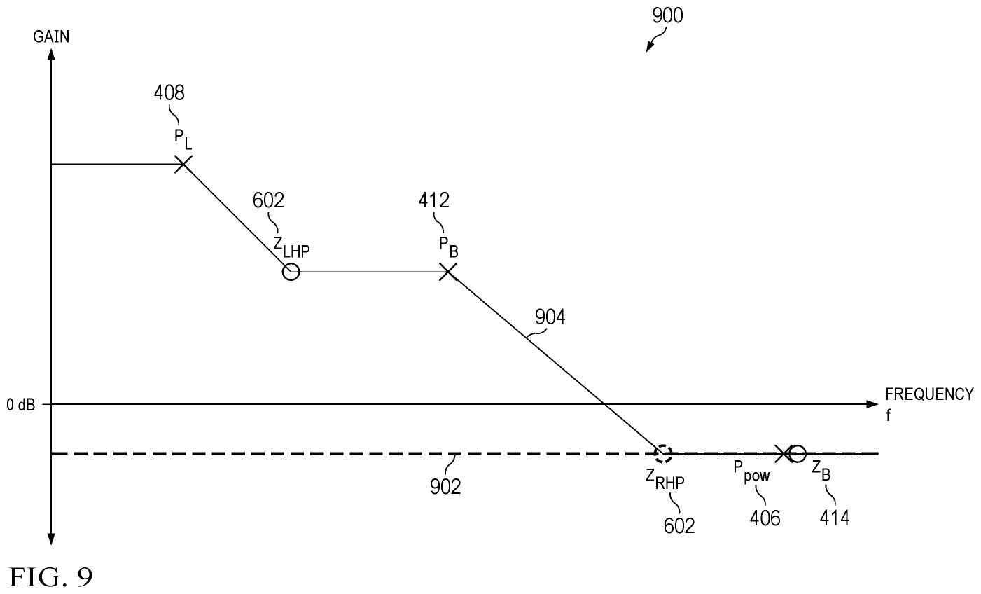

FIG. 6 is a circuit diagram of the FVF buffer in accordance with various examples herein. Some components of circuit 600 are described above with respect to FIGS. 1, 2, 3, and 4, and like numerals denote like components. Circuit 600 shows the reverse current protection transistor 210, which was omitted from FIG. 4 above. With the addition of the reverse current protection transistor 210 in circuit 600, the transfer function is different than the transfer function for circuit 400. Circuit 600 also includes a left half plane zero 602. FIGS. 6 and 7 show one example problem with circuit 600, and FIGS. 8 and 9 show an example solution to the problem.

In circuit 600, a reverse current protection transistor 210 is coupled in series with the pass transistor 202. As described above with respect to FIG. 4, if the loop is broken at the gate of pass transistor 202, two loops are formed. A first loop is found from V_{SC} 402 to node 246 (V_{MID}). This loop is in phase. The second loop goes from V_{SC} 402 through V_{OUT} at node 114, then cascode transistor 208, then the active load Z_{B} 302. The second loop is 180 degrees out of phase and provides negative feedback. With two paths, a right half plane zero (Z_{RHP} 604) often occurs in the transfer function. The modified transfer function has three zeros, one of which is a right half plane zero 604. A right half plane zero 604 is added in the FVF loop due to the non-inverting path from V_{SC} 402 to V_{MID} 246, described above. Having a right half plane zero and a non-dominant pole close to the unity gain bandwidth (UGB) may lead to a low phase margin and in some cases, instability.

FIG. 7 is a Bode plot 700 of the poles and zeros for circuit 600 in accordance with various examples herein. Curve 702 at the bottom is the positive feedback path (e.g., the first loop described above with respect to FIG. 6). In this case, the positive feedback path has less than unity gain (less than 0 dB). The right half plane zero 604 (Z_{RHP}) shown on curve 704 further drops the phase margin. This zero occurs close to the unity gain point. At this point, there is negative phase margin and the circuit could become unstable. The instability is a problem, and FIGS. 8 and 9 describe one solution to the problem.

FIG. 8 is a circuit diagram of the FVF buffer in accordance with various examples herein. Some components of circuit 800 are described above with respect to FIGS. 1, 2, 3, 4, and 6, and like numerals denote like components. In circuit 800, the reverse current protection transistor 210 is shown as a resistance 802 (R_{ON}).

As discussed above with respect to FIG. 7, the existence of a pole and a right half plane zero close to the unity gain bandwidth produces a very low phase margin. To boost the phase margin, a left hand plane zero should be inserted that tracks the dominant pole. To add this zero, R_{FVF} 106 is inserted into the signal path as shown in circuit 800. R_{FVF} 106 acts as an intentional ESR. R_{FVF} 106 ensures a left half plane zero is between load pole 408 and buffer pole 412. R_{FVF} 106 acts as an ESR for the load capacitor 108 and generates a zero that tracks the dominant load pole. The added zero increases the bandwidth of the feedback path gain and causes the right half plane zero to be pushed to a high frequency.

If the circuit has an R_{ESR} 110 that is nonzero, that ESR is added to the value of R_{FVF} 106, which could slightly shift the location of left half plane zero 602. However, left half plane zero 602 will stay between load pole 408 and buffer pole 412.

This example addresses the problems described above because the circuit described in FIG. 8 ensures the left half plane zero 602 is between load pole 408 and buffer pole 412. This example produces about 90 degrees of phase margin. This example also produces a right half plane zero (Z_{RHP} 604) close to the unity gain bandwidth. If the circuit has 90 degrees of phase margin but then loses a little phase margin because the right half plane zero 604 is not right at the unity gain bandwidth, the system may still be stable with less phase margin, such as 80 degrees, etc.

FIG. 9 is a Bode plot 900 of the poles and zeros for circuit 800 in accordance with various examples herein. Curve 902 at the bottom is the positive feedback path (e.g., the first loop described above with respect to FIG. 6). In this case, the positive feedback path has less than unity gain (less than 0 dB). Curve 904 shows the Bode plot for circuit 800 with R_{FVF} 106 added in the signal path. In curve 904, the gain is constant until it reaches the frequency of load pole 408, where the gain begins to fall. The gain levels out again at the frequency of the left half plane zero 602. The gain falls again at the frequency of the buffer pole 412. Therefore, the left half plane zero 602 between the load pole 408 and buffer pole 412 increases the bandwidth of circuit 800. The right half plane zero 604 occurs near the point of the unity gain bandwidth on curve 904. At the frequency of the right half plane zero 604, the gain levels out again as shown in Bode plot 900.

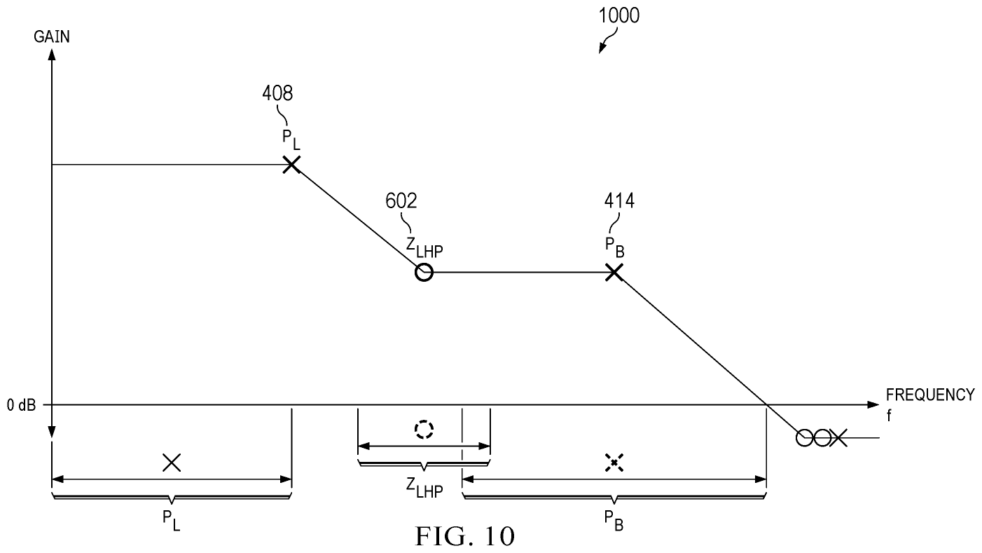

FIG. 10 is an example Bode plot 1000 of the poles and zeros in accordance with various examples herein. Bode plot 1000 shows how the poles and zeroes move in frequency. As one example, the first pole (load pole 408) is dominant. The load pole 408 moves to high frequencies as the load increases. The left half plane zero 602 represents the ESR zero. This zero is created by R_{FVF} 106 and R_{ESR} 110. Without the addition of R_{FVF} 106, the movement in frequency of left half plane zero 602 could be very large. With R_{FVF} 106 (e.g., the pseudo ESR), the movement is bounded between a smaller frequency range. The first non-dominant pole is the internal buffer pole 412, which is moved to a high frequency with a load current using an active load (e.g., load 302) as described above.

As described above, the error amplifier loop (first feedback loop 130) is a high gain and low bandwidth loop that provides excellent tracking accuracy. The dominant pole is the output pole of the error amplifier, and the loop is stabilized with the help of a constant phase compensation network. The pseudo ESR (e.g., R_{FVF} 106) described above stabilizes the second feedback loop 132. In first feedback loop 130, the feedback is taken directly from the output capacitor node (e.g., output node 114 in FIG. 2) after R_{FVF} 106. This structure ensures good load regulation. Because the feedback is taken from output node 114 (e.g., V_{OUT}), R_{FVF} 106 does not produce a zero with the load capacitor for the first feedback loop 130. However, as the load current increases, the poles may move to a higher frequency. FIGS. 11 to 14 describe this issue and how it may be managed with the examples herein.

FIG. 11 is a Bode plot 1100 of poles and zeros in accordance with various examples herein. Bode plot 1100 shows pole movement as load current increases. As load current (I_{LOAD}) increases, load pole 408 may move from frequency 408A to frequency 408B. At the higher frequency, the load pole 408 may move close to load zero 410. Similarly, as I_{LOAD} increases, buffer pole 412 may move from frequency 412A to frequency 412B. At the higher frequency, the buffer pole 412 may move close to buffer zero 414. If the circuit did not have a load zero 410 (Z_{L}), then in some cases load pole 408 could move all the way to the frequency of buffer pole 412. That movement could cause a complex pole formation.

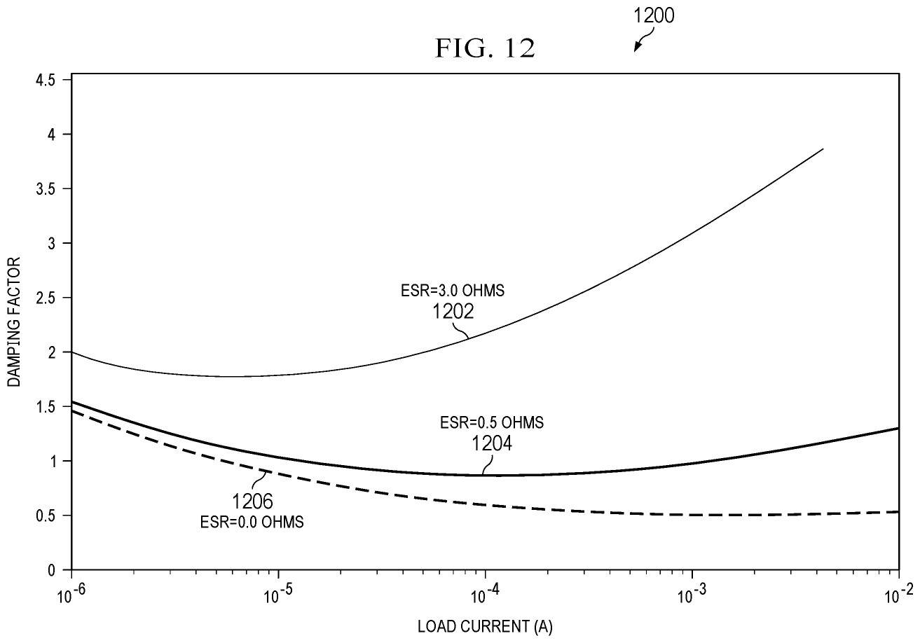

FIG. 12 is a graph 1200 of a damping factor versus load current in accordance with various examples herein. As described above with respect to FIG. 11, if the value of the ESR is low, the load pole 408 may reach the buffer pole 412, which can result in the formation of complex poles. Graph 1200 shows the damping factor versus load current, with damping factor on the x-axis and load current on the y-axis. Graph 1200 includes three curves 1202, 1204, and 1206, which correspond to different values of ESR. The curves in graph 1200 correspond to one example, and therefore the graph may be different for other examples.

The damping factor measures the separation of the complex poles. The damping factor is at a minimum for a low output capacitance, because the load pole 408 is closer to the buffer pole 412 at no load. If the damping factor is less than 1.0, complex poles form. If the damping factor falls below 0.7, the complex poles result in gain peaking, which may result in instability. Curve 1206 shows the example damping factor with no ESR (0 Ohms) in the system. As the load current increases, curve 1206 falls below a 1.0 damping factor, and then continues to fall below 0.5. Curve 1206 would produce gain peaking in the system, which indicates a complex pole.

Curve 1204 corresponds to a system with an ESR of 0.5 Ohms. With an ESR of 0.5 Ohms, the damping factor falls below 1.0 but stays above 0.7, so gain peaking may not occur. Curve 1206 corresponds to a system with an ESR of 3 Ohms. The bandwidth of this loop is high enough that complex poles will not form (e.g., the damping factor stays above 1.0). This example produces a second order system with the poles separated.

Therefore, in some examples, having a pseudo ESR of 0.5 Ohms or more (which is added to the total ESR of the system) provides a higher damping ratio and ensures that there will be no gain peaking in the system. This is because the FVF buffer pushes out the load pole in frequency as the load current increases by reducing the output impedance. Adding a pseudo ESR (e.g., with R_{FVF} 106) ensures a minimum impedance of R_{FVF} looking into the buffer. This impedance limits how far the load pole can be pushed out and stops the formation of complex poles (e.g., P_{L}<P_{B} with R_{FVF} in the circuit).

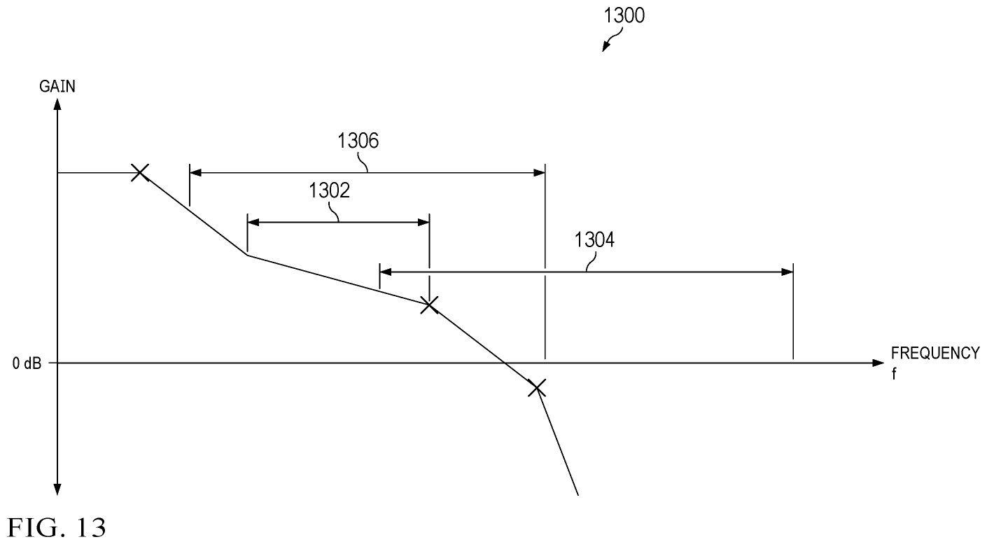

FIG. 13 is a Bode plot 1300 in accordance with various examples herein. Bode plot 1300 provides a summary of the loop stability of the first feedback loop 130 (e.g., the error amplifier loop or the slow loop). A constant phase network keeps the phase constant throughout the frequency range. Range 1302 in Bode plot 1300 demonstrates this range. Range 1304 represents the movement of the buffer pole 412. Range 1306 represents the movement of the load pole 408, which is limited by the pseudo ESR.

The first feedback loop 130 output pole (load pole 408) is dominant because high DC gain is needed to achieve good output accuracy. A low frequency constant phase network is used to boost phase while attenuating the gain so that the overall loop bandwidth is limited. As described above, the load pole 408 is pushed out to a high frequency as load current increases. For a small output capacitance, load pole 408 may move out and form a complex pole pair with buffer pole 412. However, the movement of load pole 408 is limited by adding R_{FVF} 106 as a pseudo ESR, which keeps the load pole 408 at a lower frequency than the buffer pole 412 in all cases. The value of R_{FVF} 106 is chosen such that the load pole 408 stops before the buffer pole 412 for a low output capacitance (e.g., 0.5 μF) to ensure no complex pole formation. For a significant load capacitance, an additional zero may exist between load pole 408 and buffer pole 412. The constant phase network ensures that the gain intersects the UGB frequency with −30 dB per decade slope in the worst case scenario. This ensures a minimum phase margin of 45 degrees.

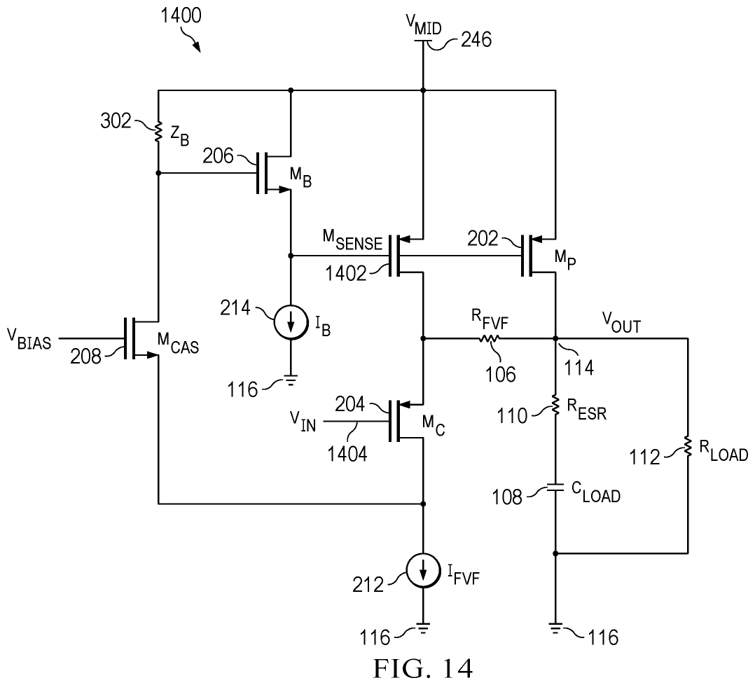

In the examples described herein, an R_{VFV} 106 is added to the LDO, and feedback is taken on each side of R_{FVF} 106. A voltage drop occurs across R_{FVF} 106. There is also a voltage drop from V_{INT} at voltage terminal 256 across the reverse current protection transistor 210, and another voltage drop across pass transistor 202. These voltage drops add up to the total voltage drop between V_{IN} at voltage terminal 256 and V_{OUT} at output node 114. FIG. 14 provides one example circuit structure for removing the R_{FVF} 106 voltage drop.

FIG. 14 is a circuit diagram of the FVF buffer in accordance with various examples herein. Some components of circuit 1400 are described above with respect to FIGS. 1, 2, 3, 4, 6, and 8, and like numerals denote like components. Circuit 1400 shows the FVF buffer described above with the addition of a sense transistor 1402 (M_{SENSE}). V_{IN} 404 represents the signal provided to the gate of control transistor 204 from the first feedback loop 130 (see, e.g., FIG. 2).

To avoid the use of a resistor (R_{FVF} 106) in the load current path, sense transistor 1402 is added to inject a current proportional to the load through R_{FVF} 106, which introduces a zero in the loop that tracks the output pole. Sense transistor 1402 mimics the pass transistor 202. Any change in voltage across pass transistor 202 is mirrored with sense transistor 1402. That voltage change is captured through the control transistor 204 and fed back via a feedback loop. The feedback loop in this example includes sense transistor 1402 and the control transistor 204. The effects of R_{FVF} 106 are realized without having R_{FVF} 106 in the path of the pass transistor 202.

The R_{FVF} 106 resistive value realized in circuit 1400 may be found via equation (1):

$${R}_{F V F} = \frac{( {W}_{P} / {L}_{P} )}{( {W}_{S} / {L}_{S} )} {R}_{INT} \qquad ( 1 )$$

In equation (1), the R_{INT} value is multiplied by the ratios of the width and lengths of the sense transistor 1402 and the pass transistor 202 to get R_{FVF} 106. WP is the width of pass transistor 202, and LP is the length of pass transistor 202. W_{S} is the width of sense transistor 1402, and Ls is the length of sense transistor 1402.

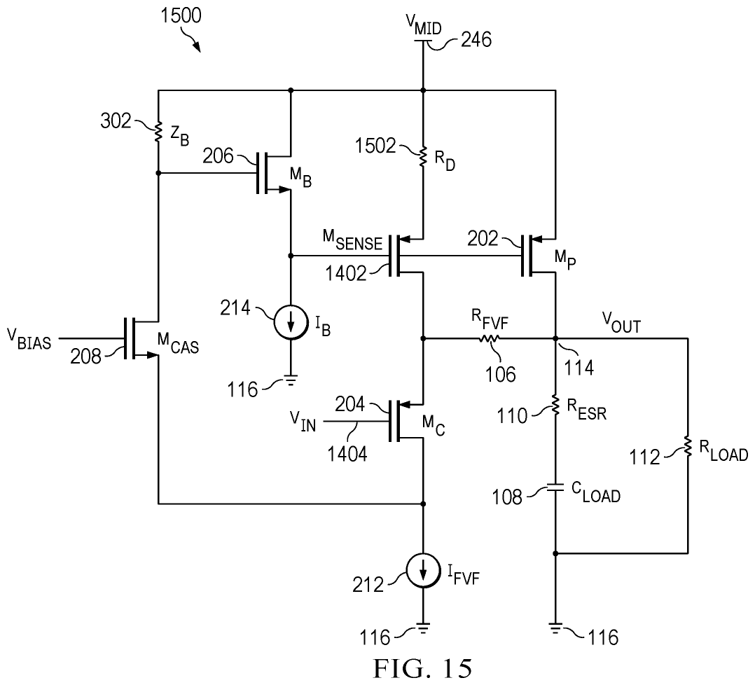

FIG. 15 is a circuit diagram of the FVF buffer in accordance with various examples herein. Some components of circuit 1500 are described above with respect to FIGS. 1, 2, 3, 4, 6, 8, and 14, and like numerals denote like components. Circuit 1500 shows the FVF buffer described above with the addition of a degeneration resistor 1502 (R_{D}).

Circuit 1500 includes the pass transistor 202 and sense transistor 1402 described above with respect to FIG. 14. For light loads, pass transistor 202 and sense transistor 1402 have a transconductance (gₘ) ratio that is proportional to their width-to-length ratios. As the load current increases, however, the gₘ ratio decreases. This decrease means that sense transistor 1402 appears smaller than its actual size due to the degeneration. As the load increases, the ESR zero needs to move to higher frequencies to boost the phase margin. Therefore, the pass transistor 202 to sense transistor 1402 ratio also needs to increase as load current increases. This increase may be realized by adding the degeneration resistor 1502. The degeneration resistor 1502 increases R_{INT} at higher loads according to equations (2) and (3):

$${R}_{I N T} = \frac{gms}{gmp} * {R}_{F V F} at light loads \qquad ( 2 )$$

$${R}_{I N T} = \frac{1 / {R}_{D}}{g m p} * {R}_{F V F} at full load \qquad ( 3 )$$

In examples herein, a sense transistor and/or a resistor may be added to generate a pseudo ESR in a flipped-voltage-follower LDO loop that enables zero to high ESR support. The added sense transistor and resistor structure in the FVF loop avoids complex pole formation in the high gain error amplifier loop, which allows a large resistive value of a buffer zero that enables a low I_{Q} FVF loop design. The right half plane zero introduced due to a reverse current protection transistor is compensated by the added left half plane pseudo ESR zero.

In examples herein, the high-speed FVF loop is stabilized for zero to high ESR. The examples herein avoid complex pole gain peaking without increasing I_{Q} in the FVF loop, which leads to an overall low I_{Q} design. The right half plane zero effect from a reverse current protection transistor may be nullified without degrading transient performance. In one solution, a resistor is not present in the load current path, so the voltage drop across the resistor does not add to dropout voltage. In addition, no high voltage capacitors are used in the implementations, which reduces overall area of the circuit.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be coupled to at least some of the passive elements and/or the sources to form the described structure either at a time of manufacture or after a time of manufacture, for example, by an end-user and/or a third-party.

While certain components may be described herein as being of a particular process technology, these components may be exchanged for components of other process technologies. Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

Uses of the phrase “ground voltage potential” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter. Modifications are possible in the described examples, and other examples are possible within the scope of the claims.

What is claimed is:

1. A voltage regulator, comprising:
a first feedback loop, wherein the first feedback loop includes:
a first transistor coupled to an input voltage terminal;
a second transistor coupled to the first transistor;
a third transistor coupled to the second transistor; and
a fourth transistor coupled to the third transistor and a gate of the first transistor;
a resistor having a first terminal and a second terminal, the first terminal coupled to the first transistor and the second transistor; and
a second feedback loop, wherein the second feedback loop includes:
an amplifier having a first amplifier input coupled to the second terminal of the resistor, a second amplifier input coupled to a voltage source, and an amplifier output coupled to a gate of the second transistor.

2. The voltage regulator of claim 1, wherein the first transistor includes a source coupled to a drain of the fourth transistor, a gate coupled to a source of the fourth transistor, and a drain coupled to the resistor and a source of the second transistor.

3. The voltage regulator of claim 1, wherein the second transistor includes a source coupled to the resistor and a drain of the first transistor, and a drain coupled to a source of the third transistor and a current source.

4. The voltage regulator of claim 1, wherein the fourth transistor includes a gate coupled to a drain of the third transistor, a drain coupled to a source of the first transistor, and a source coupled to the gate of the first transistor and to a current source.

5. The voltage regulator of claim 1, further comprising:
a fifth transistor having a source coupled to the input voltage terminal, a gate coupled to a bias voltage source, and a drain coupled to a source of the first transistor.

6. The voltage regulator of claim 1, wherein a gate of the fourth transistor and a drain of the third transistor are configured to be coupled to an active load.

7. The voltage regulator of claim 1, wherein the first transistor is a pass transistor, the second transistor is a control transistor, the third transistor is a cascode transistor, and the fourth transistor is a buffer transistor.

8. A voltage regulator, comprising:
a first feedback loop, wherein the first feedback loop includes:
a pass transistor coupled to an input voltage terminal;
a sense transistor coupled to the pass transistor;
a control transistor coupled to the sense transistor;
a cascode transistor coupled to the control transistor; and
a buffer transistor coupled to the cascode transistor and a gate of the sense transistor;
a resistor having a first terminal and a second terminal, the first terminal coupled to the sense transistor and the control transistor; and
a second feedback loop, wherein the second feedback loop includes:
an amplifier having a first amplifier input coupled to the second terminal of the resistor, a second amplifier input coupled to a voltage source, and an amplifier output coupled to a gate of the control transistor.

9. The voltage regulator of claim 8, wherein the pass transistor includes a source coupled to a drain of the buffer transistor and to a source of the sense transistor, a gate coupled to a gate of the sense transistor and to a source of the buffer transistor, and a drain coupled to the second terminal of the resistor.

10. The voltage regulator of claim 8, wherein the control transistor includes a source coupled to the first terminal of the resistor and a drain of the sense transistor, and a drain coupled to a source of the cascode transistor and a current source.

11. The voltage regulator of claim 8, wherein the buffer transistor includes a gate coupled to a drain of the cascode transistor, a drain coupled to a source of the pass transistor and a source of the sense transistor, and a source coupled to the gate of the pass transistor, the gate of the sense transistor, and a current source.

12. The voltage regulator of claim 8, further comprising:
a reverse current protection transistor having a source coupled to the input voltage terminal, a gate coupled to a bias voltage source, and a drain coupled to a source of the pass transistor.

13. The voltage regulator of claim 8, wherein a gate of the buffer transistor and a drain of the cascode transistor are configured to be coupled to an active load.

14. The voltage regulator of claim 8, wherein the sense transistor includes a source coupled to a first terminal of a degeneration resistor, and wherein a second terminal of the degeneration resistor is coupled to a source of the pass transistor.

15. The voltage regulator of claim 8, wherein the amplifier is a transconductance amplifier.

16. A low-dropout voltage regulator, comprising:
a pass transistor having a flipped-voltage-follower configuration with a control transistor, wherein a drain of the pass transistor is configured to provide an output voltage of the low-dropout voltage regulator;
a first feedback loop for the voltage regulator, wherein the first feedback loop is configured to provide a load transient response, and wherein the first feedback loop includes:
the pass transistor and the control transistor;
a cascode transistor coupled to the control transistor; and
a buffer transistor coupled to the cascode transistor and a gate of the pass transistor;
a resistor having a first terminal and a second terminal, the first terminal coupled to the pass transistor and the control transistor; and
a second feedback loop for the voltage regulator, wherein the second feedback loop is configured to provide load regulation, and the second feedback loop includes:
an amplifier having a first amplifier input coupled to the second terminal of the resistor, a second amplifier input coupled to a voltage source, and an amplifier output coupled to a gate of the control transistor.

17. The low-dropout voltage regulator of claim 16, wherein the amplifier is an error amplifier.

18. The low-dropout voltage regulator of claim 16, wherein the resistor provides a zero in a transfer function of the first feedback loop.

19. The low-dropout voltage regulator of claim 16, wherein the resistor bounds a frequency of an output pole in a transfer function of the first feedback loop.

20. The low-dropout voltage regulator of claim 16, wherein the resistor provides a zero in a transfer function of the first feedback loop that has a frequency between a load pole frequency and a buffer pole frequency of the transfer function.
